(19) United States
(12) Patent Application Publication
(10) Pub. No.: US 2019/0243456 A1
(43) Pub. Date: Aug. 8, 2019

(54) METHOD AND DEVICE FOR RECOGNIZING A GESTURE, AND DISPLAY DEVICE

(71) Applicant: BOE Technology Group Co., Ltd., Beijing (CN)

(72) Inventors: Yanling HAN, Beijing (CN); Xue DONG, Beijing (CN); Haisheng WANG, Beijing (CN); CHUN-WEI WU, Beijing (CN); Xiaoliang DING, Beijing (CN); Yingming LIU, Beijing (CN); Chih-Jen CHENG, Beijing (CN); Yuzhen GUO, Beijing (CN)

(21) Appl. No.: 15/772,704

(22) PCT Filed: Oct. 11, 2017
(86) PCT No.: PCT/CN2017/105735

§ 371 Date: May 1, 2018

(30) Foreign Application Priority Data
Mar. 8, 2017 (CN) 201710134258.4

(51) Int. Cl. G06F 3/01; G06F 3/0481; G06K 9/00

(52) U.S. Cl. CPC G06F 3/017; G06K 9/00355; G06F 3/04815

(57) ABSTRACT

There are disclosed a device and method for recognizing a gesture, and a display device, so as to recognize a gesture on a 3D display. A device for recognizing a gesture according to the present disclosure includes: a depth-of-focus position recognizer configured to recognize a depth-of-focus position of a gesture of a user; and a gesture recognizer configured to recognize the gesture according to the depth-of-focus position of the gesture of the user and a 3D display image.

This application is a US National Stage of International Application No. PCT/CN 2017/105735, filed on Oct. 11, 2017, designating the United States and claiming priority to Chinese Patent Application No. 201710134258.4, filed with the Chinese Patent Office on Mar. 8, 2017, and entitled “A method and device for recognizing a gesture, and a display device”, the content of which is hereby incorporated by reference in its entirety.

### FIELD

The present disclosure relates to the field of display technologies, and particularly to a method and device for recognizing a gesture, and a display device.

### BACKGROUND

In the prior art, an operation object of a gesture of a user can be determined according to x and y coordinates on a two-dimension (2D) display, but there is still some obstacle to controlling an object on a three-dimension (3D) display, particularly in that a number of objects at the same x and y coordinates but different depths of focus cannot be distinguished from each other, that is, such one of the objects in the 3D space cannot be recognized that is interesting to the user and to be operated on by the user.

### SUMMARY

Embodiments of the present disclosure provide a method and device for recognizing a gesture, and a display device, so as to recognize a gesture on a 3D display.

An embodiment of the present disclosure provides a device for recognizing a gesture, the device including: a depth-of-focus position recognizer configured to recognize a depth-of-focus position of a gesture of a user; and a gesture recognizer configured to recognize the gesture according to the depth-of-focus position of the gesture of the user and a 3D display image.

With this device, the depth-of-focus position recognizer recognizes the depth-of-focus position of the gesture of the user, and the gesture recognizer recognizes the gesture according to the depth-of-focus position of the gesture of the user and the 3D display image, so that a gesture on a 3D display can be recognized.

Optionally the device further includes: a calibrator configured to preset a plurality of ranges of operation depth-of-focus levels for the user.

Optionally the depth-of-focus position recognizer is configured to recognize a range of operation depth-of-focus levels corresponding to the depth-of-focus position of the gesture of the user.

Optionally the gesture recognizer is configured to recognize the gesture on an object in the 3D display image in the range of operation depth-of-focus levels corresponding to the depth-of-focus position of the gesture of the user.

Optionally the calibrator is configured: to preset the plurality of ranges of operation depth-of-focus levels for the user according to ranges of depths of focus of gestures of the user acquired when the user makes the gestures on objects at the different depths of focus in the 3D display image.

Optionally the device further includes: a calibrator configured to predetermine a correspondence relationship between a value of operation depth of focus in a user gesture and a value of depth of focus in a 3D display image.

Optionally the gesture recognizer is configured: to determine a value of depth of focus in the 3D display image corresponding to the depth-of-focus position of the gesture of the user according to the correspondence relationship, and to recognize the gesture in the 3D display image with the value of depth of focus.

Optionally the calibrator is configured: to predetermine the correspondence relationship between a value of operation depth of focus in a user gesture and a value of depth of focus in a 3D display image according to normalized coordinates in the largest range of depths of focus that can be reached by a gesture of a user, and normalized coordinates in the largest range of depths of focus for a 3D display image.

Optionally the depth-of-focus position recognizer is configured to recognize the depth-of-focus position of the gesture of the user using a sensor and/or a camera; and the gesture recognizer is configured to recognize the gesture using a sensor and/or a camera.

Optionally the sensor includes one or a combination of an infrared photosensitive sensor, a radar sensor, and an ultrasonic sensor.

Optionally sensors are distributed at four of up, down, left and right edge frames of a non-display area.

Optionally the gesture recognizer is further configured to track using pupils, and to determine a sensor for recognizing the depth-of-focus position of the gesture of the user.

Optionally the sensors are arranged above one of: a color filter substrate, an array substrate, a backlight plate, a printed circuit board, a flexible circuit board, a back plane, and a cover plate glass.

An embodiment of the present disclosure provides a display device including the device according to the embodiment of the present disclosure.

An embodiment of the present disclosure provides a method for recognizing a gesture, the method including: recognizing a depth-of-focus position of a gesture of a user; and recognizing the gesture according to the depth-of-focus position of the gesture of the user and a 3D display image.

Optionally the method further includes: presetting a plurality of ranges of operation depth-of-focus levels for the user.

Optionally recognizing the depth-of-focus position of the gesture of the user includes: recognizing a range of operation depth-of-focus levels corresponding to the depth-of-focus position of the gesture of the user.

Optionally recognizing the gesture according to the depth-of-focus position of the gesture of the user and the 3D display image includes: recognizing the gesture on an object in the 3D display image in the range of operation depth-of-focus levels corresponding to the depth-of-focus position of the gesture of the user.

Optionally presetting the plurality of ranges of operation depth-of-focus levels for the user includes: presetting the plurality of ranges of operation depth-of-focus levels for the user according to ranges of depths of focus of gestures of the user acquired when the user makes the gestures on objects at the different depths of focus in the 3D display image.

Optionally the method further includes: predetermining a correspondence relationship between a value of operation depth of focus in a user gesture and a value of depth of focus in a 3D display image.

Optionally recognizing the gesture according to the depth-of-focus position of the gesture of the user and the 3D display image includes: determining a value of depth of focus in the 3D display image corresponding to the depth-of-focus position of the gesture of the user according to the correspondence relationship, and recognizing the gesture in the 3D display image with the value of depth of focus.

Optionally predetermining the correspondence relationship between a value of operation depth of focus in a user gesture and a value of depth of focus in a 3D display image includes: predetermining the correspondence relationship between a value of operation depth of focus in a user gesture, and a value of depth of focus in a 3D display image according to normalized coordinates in the largest range of depths of focus that can be reached by a gesture of a user, and normalized coordinates in the largest range of depths of focus for a 3D display image.

### BRIEF DESCRIPTION OF THE DRAWINGS

In order to make the technical solutions according to the embodiments of the present disclosure more apparent, the drawings to which reference is made in the description of the embodiments will be introduced briefly, and apparently the drawings to be described below are only some embodiments of the present disclosure, and those ordinarily skilled in the art can further derive other drawings from these drawings here without any inventive.

FIG. 1 is a schematic principle diagram of defined depth-of-focus levels according to an embodiment of the present disclosure;

FIG. 2 is a schematic flow chart of a method for recognizing a gesture according to an embodiment of the present disclosure;

FIG. 3 is a schematic principle diagram of normalizing a depth of focus range according to an embodiment of the present disclosure;

FIG. 4 is a schematic flow chart of a method for recognizing a gesture according to an embodiment of the present disclosure;

FIG. 5 is a schematic structural diagram of a device for recognizing a gesture according to an embodiment of the present disclosure;

FIG. 6 is a schematic diagram of a camera and a sensor arranged on a display device according to an embodiment of the present disclosure;

FIG. 7 is a schematic diagram of a sensor arranged on a cover plate glass of a display device according to an embodiment of the present disclosure;

FIG. 8 is a schematic diagram of a photosensitive sensor integrated with a pixel according to an embodiment of the present disclosure;

FIG. 9 is a schematic diagram of a sensor arranged on a back plane according to an embodiment of the present disclosure;

FIG. 10 is a schematic diagram of a plurality of sensors in a non-display area of a display panel according to an embodiment of the present disclosure; and

FIG. 11 is a schematic diagram of sensors and a plurality of cameras arranged in a non-display area of a display panel according to an embodiment of the present disclosure.

### DETAILED DESCRIPTION OF THE EMBODIMENTS

The embodiments of the present disclosure provide a device and method for recognizing a gesture, and a display device, so as to recognize a gesture on a 3D display.

The embodiments of the present disclosure provide a method for recognizing a gesture on a 3D display, and a corresponding display panel and display device, and particularly relate to: 1. a solution to matching a depth of focus of a 3D display to a sight of human eyes so that a person performs a gesture operation on a really touched image in a 3D space; 2. a hardware solution in which multiple technologies are integrated with multi-sensor sensing to thereby make use of their advantages and make up each other's disadvantages so as to detect a gesture precisely in a full range; and 3. a solution in which pupils are tracked to preliminarily determine an angle of view of a person, and an object to be operated by the person, and a gesture is detected using a sensor at a corresponding orientation as a primary sensor, thus greatly improving the precision of detection so as to prevent an operational error.

Firstly a first method for recognizing a gesture on a 3D display according to an embodiment of the present disclosure will be introduced, where depth-of-focus levels are defined in a 3D display space and a gesture operation space to thereby enable a user to control display objects at the same orientation but different depths of focus. Furthermore there is further provided a second method for controlling a display object at any depth of focus by comparing the coordinates of the position of a gesture with the coordinates of the depth of focus of a 3D image.

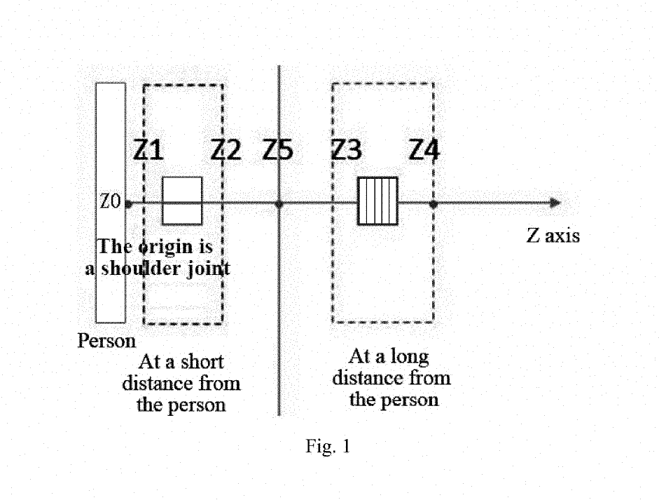

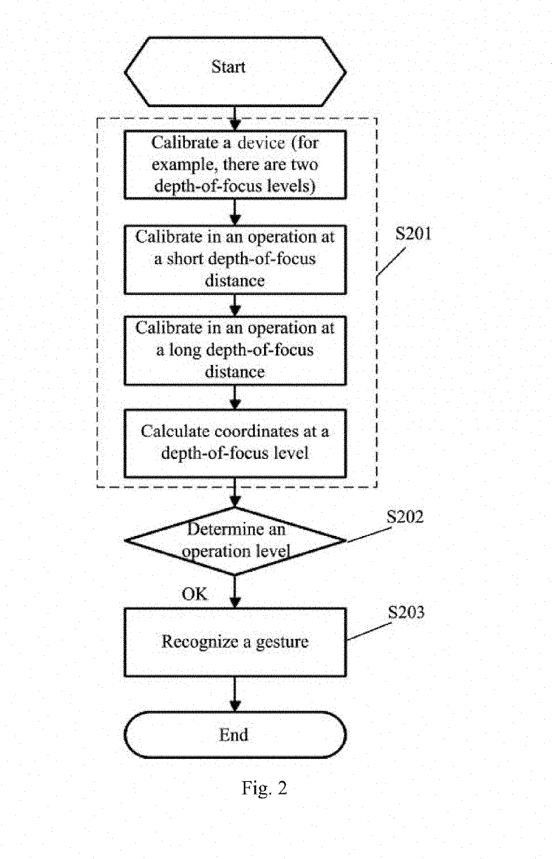

FIG. 1 illustrates a principle of the first method in which depth-of-focus levels are defined in a 3D display space and a gesture operation space to thereby control display objects at the same orientation but different depths of focus, and FIG. 2 illustrates a particular method for recognizing a gesture, where the method includes the following steps.

The step S201 is to calibrate a device, where depth-of-focus levels corresponding to an operating habit of a human operator are defined by presetting a plurality of ranges of operation depth-of-focus levels for the user. For example, there are operations at different depth-of-focus levels corresponding to different extension states of an arm of the gesturing making operator with reference to his or her shoulder joint. Given two depth-of-focus levels, for example, while a 3D image is being displayed, the device asks the user to operate on an object closer thereto, and the human operator performs operations of leftward, rightward, upward, downward, frontward pushing, and backward pulling, so the device acquires a range of coordinates of depths of focus as Z1 to Z2. At this time, the arm shall be bent, and the hand shall be closer to the shoulder joint. Alike the device asks the user to operate on an object further therefrom, and acquires a range of coordinates of depths of focus as Z3 to Z4. At this time, the arm shall be straight or less bent, and the hand shall be further from the shoulder joint. A midpoint Z5 between Z2 and Z3 is defined as a dividing line between near and far operations, thus resulting in two of near and far depth-of-focus operation spaces, where Z1<Z2<Z5<Z3<Z4. Accordingly in a real application, if the Z-axis coordinate of a gesture, which is less than Z5 is acquired, then it may be determined that the user is operating on an object closer thereto, and there is a corresponding range of depth-of-focus coordinates, Z1 to Z2, which is referred to a first range of operation depth-of-focus levels, for example; otherwise, it may be determined that the user is operating on an object further therefrom, and there is a corresponding range of depth-of-focus coordinates, Z3 to Z4, which is referred to a second range of operation depth-of-focus levels, for example.

However as the person is moving in position, the value of Z5 may vary, and in order to account for this, referring to FIG. 1, the device acquires the coordinate of the depth-of-focus of the shoulder joint as Z0, and subtracts Z0 from all the acquired values of Z1 to Z5 to convert them into coordinates with reference to the shoulder joint of the person, so that the depth of focus of an operation can be determined without being affected by the free movement of the person. If the coordinate of the gesture, which is less than (Z5−Z0), is acquired, then it may be determined that the user is operating on an object closer thereto; otherwise, it may be determined that the user is operating on an object further therefrom.

The step S202 is to determine an operation level, where a specific operating human or operating hand is determined before a gesture is recognized, but an improvement is made in this method in that a specific depth-of-focus level of an operation is determined according to the coordinates of the center of the hand, and indicated on the displayed image. If the coordinate of the gesture, which is less than (Z5−Z0), is acquired, then the operation may be an operation on an object closer to the person, that is, the gesture of the current user is operating in the first range of operation depth-of-focus levels; otherwise, the operation may be an operation on an object further from the person, that is, the gesture of the current user is operating in the second range of operation depth-of-focus levels.

The step S203 is to recognize a gesture, where the operation of the gesture is equivalently fixed at a specific depth of focus after the depth-of-focus level is determined, that is, an object on a 2D display is controlled, so simply a normal gesture is recognized. Stated otherwise, after the depth of focus is determined, there is only one object at the same x and y coordinates in the range of operation depth-of-focus levels, the x and y coordinates of the gesture are acquired, an object to be operated on is determined, and a normal gesture operation is further performed thereon.

In the second method, a display object at any depth of focus is controlled by comparing the coordinates of the position of a gesture with the coordinates of the depth of focus of a 3D image. This method will not be limited to any definition of depth-of-focus levels, but can control an object at any depth of focus. A particular method for recognizing a gesture includes the following operations.

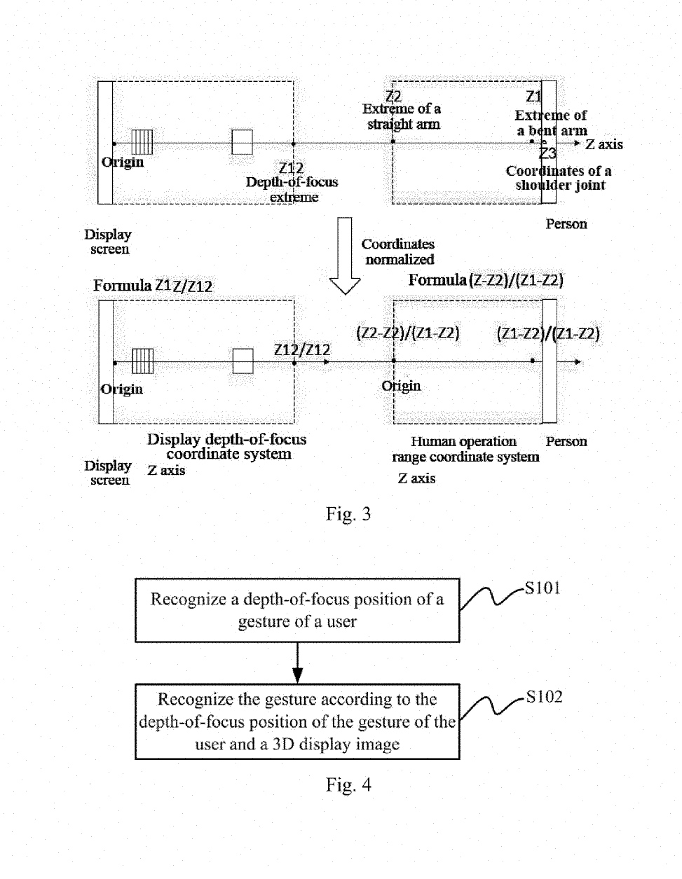

A device is calibrated, where a range of depths of focus (delimited by extremes of a straight arm and a curved arm) that can be reached by a gesture of a human operator is measured with reference to a shoulder joint. Coordinates in a range of depths of focus for a 3D display image, and coordinates in the range of depths of focus that can be reached by a gesture of a human operator are normalized, that is, a correspondence relationship between a value of operation depth of focus in a user gesture and a value of depth of focus in a 3D display image is predetermined. Particularly the coordinate Z1 of the hand is measured when the arm is curved, and the coordinate Z2 of the hand is measured when the arm is straight, so the operation range of the person is defined as Z1 to Z2. Z2 is subtracted from the coordinate of the recognized hand of the person, and their difference is further divided by (Z2−Z1), so that the coordinates in the operation range of the person are normalized. As illustrated in FIG. 3, the upper section shows measured values of coordinates acquired by a gesture sensor, and the lower section shows values normalized into a display depth-of-focus coordinate system and an operation space coordinate system, where there is a correspondence relationship between points with the same values in the two coordinate systems. Particularly the values are normalized into the operation space coordinate system using Z2, and as the position of the person is varying, the value of Z2 may vary, but the value of Z2 shall be measured when the arm of the person is straight; and in order to improve the experience of the user, new Z2′ is measured with reference to the shoulder joint (because there is a fixed distance between Z2 and the shoulder joint), that is, Z2′=Z3′−(Z3−Z2), so the modified conversion formula shall be applied when the position of the person is changed.

Coordinates are compared, where a value of depth of focus of the gesture is mapped to a 3D image value of depth of focus, that is, the value of depth of focus in the 3D display image corresponding to the value of depth of focus of the gesture of the user is determined according to the correspondence relationship, and particularly the coordinate of the gesture is measured and normalized into a coordinate value, which is transmitted to the 3D display depth-of-focus coordinate system, and mapped to an object at a corresponding 3D depth of focus.

A gesture is recognized, where the gesture is recognized according to the corresponding 3D image value of depth of focus.

In summary, referring to FIG. 4, a method for recognizing a gesture according to an embodiment of the present disclosure includes the following steps.

The step S101 is to recognize a depth-of-focus position of a gesture of a user.

The step S102 is to recognize the gesture according to the depth-of-focus position of the gesture of the user and a 3D display image.

Optionally the method further includes presetting a plurality of ranges of operation depth-of-focus levels for the user.

Optionally the depth-of-focus position of the gesture of the user is recognized particularly by recognizing a range of operation depth-of-focus levels corresponding to the depth-of-focus position of the gesture of the user.

Optionally the gesture is recognized according to the depth-of-focus position of the gesture of the user and the 3D display image by recognizing the gesture on an object in the 3D display image in the range of operation depth-of-focus levels corresponding to the depth-of-focus position of the gesture of the user.

Optionally the plurality of ranges of operation depth-of-focus levels are preset for the user particularly by presetting the plurality of ranges of operation depth-of-focus levels for the user according to ranges of depths of focus of gestures of the user acquired when the user makes the gestures on objects at the different depths of focus in the 3D display image.

For example, there are operations at different depth-of-focus levels corresponding to different extension states of an arm of the gesturing making operator with reference to his or her shoulder joint. As illustrated in FIG. 1, given two depth-of-focus levels, while a 3D image is being displayed, the device asks the user to operate on an object closer thereto, and the human operator performs operations of leftward, rightward, upward, downward, frontward pushing, and backward pulling, so the device acquires a range of coordinates of depths of focus as Z1 to Z2. At this time, the arm shall be bent, and the hand shall be closer to the shoulder joint. Alike the device asks the user to operate on an object further therefrom, and acquires a range of coordinates of depths of focus as Z3 to Z4. At this time, the arm shall be straight or less bent, and the hand shall be further from the shoulder joint. A midpoint Z5 between Z2 and Z3 is defined as a dividing line between near and far operations, thus resulting in two near and far depth-of-focus operation spaces, where Z1<Z2<Z5<Z3<Z4. Accordingly in a real application, if the Z-axis coordinate of a gesture, which is less than Z5 is acquired, then it may be determined that the user is operating on an object closer thereto, and there is a corresponding range of depth-of-focus coordinates, Z1 to Z2, which is referred to a first range of operation depth-of-focus levels, for example; otherwise, it may be determined that the user is operating on an object further therefrom, and there is a corresponding range of depth-of-focus coordinates, Z3 to Z4, which is referred to a second range of operation depth-of-focus levels, for example.

However as the person is moving in position, the value of Z5 may vary, and in order to account for this, referring to FIG. 1, the device acquires the coordinate of the depth-of-focus of the shoulder joint as Z0, and subtracts ZO from all the acquired values of Z1 to Z5 to convert them into coordinates with reference to the shoulder joint of the person, so that the depth of focus of an operation can be determined without being affected by the free movement of the person. If the coordinate of the gesture, which is less than (Z5−Z0), is acquired, then it may be determined that the user is operating on an object closer thereto; otherwise, it may be determined that the user is operating on an object further therefrom.

Optionally the method further includes predetermining a correspondence relationship between a value of operation depth of focus in a user gesture and a value of depth of focus in a 3D display image.

Optionally the gesture is recognized according to the depth-of-focus position of the gesture of the user and the 3D display image particular as follows.

A value of depth of focus in the 3D display image corresponding to the depth-of-focus position of the gesture of the user is determined according to the correspondence relationship, and the gesture is recognized in the 3D display image with the value of depth of focus.

Optionally the correspondence relationship between a value of operation depth of focus in a user gesture and a value of depth of focus in a 3D display image is predetermined particularly as follows.

The correspondence relationship between a value of operation depth of focus in a user gesture and a value of depth of focus in a 3D display image is predetermined according to normalized coordinates in the largest range of depths of focus that can be reached by a gesture of a user, and in the largest range of depths of focus for a 3D display image.

For example, a range of depths of focus (delimited by extremes of a straight arm and a curved arm) that can be reached by a gesture of a human operator is measured with reference to a shoulder joint. Coordinates in a range of depths of focus for a 3D display image, and coordinates in the range of depths of focus that can be reached by a gesture of a human operator are normalized to predetermine a correspondence relationship between a value of operation depth of focus for a user gesture and a value of depth of focus for a 3D display image. Particularly the coordinate Z1 of the hand is measured when the arm is curved, and the coordinate Z2 of the hand is measured when the arm is straight, so the operation range of the person is defined as Z1 to Z2. Z2 is subtracted from the coordinate of the recognized hand of the person, and their difference is further divided by (Z2−Z1), so that the coordinates in the operation range of the person are normalized. As illustrated in FIG. 3, the upper section shows measured values of coordinates acquired by a gesture sensor, and the lower section shows values normalized into a display depth-of-focus coordinate system and an operation space coordinate system, where there is a correspondence relationship between points with the same values in the two coordinate systems. Particularly the values are normalized into the operation space coordinate system using Z2, and as the position of the person is varying, the value of Z2 may vary, but the value of Z2 shall be measured when the arm of the person is straight; and in order to improve the experience of the user, new Z2′ is measured with reference to the shoulder joint (because there is a fixed distance between Z2 and the shoulder joint), that is, Z2′=Z3′−(Z3−Z2), so the modified conversion formula shall be applied when the position of the person is changed.

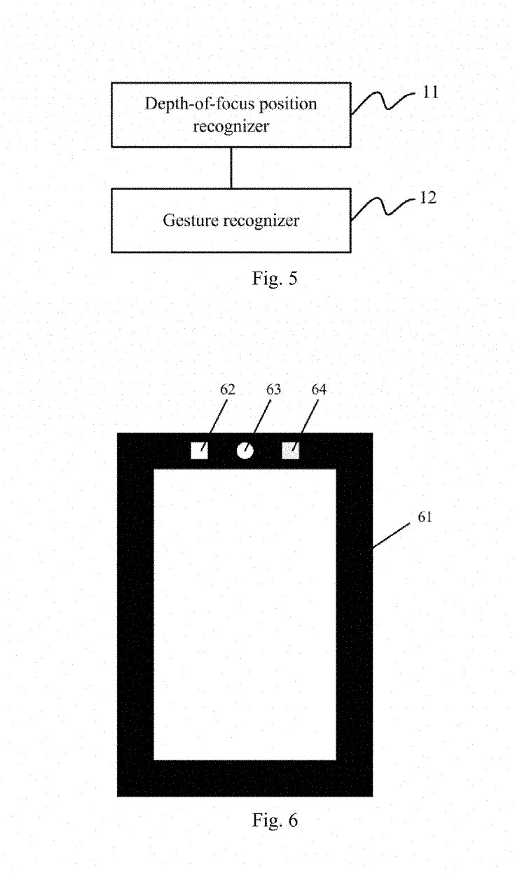

In correspondence to the method above, referring to FIG. 5, a device for recognizing a gesture according to an embodiment of the present disclosure includes the following devices.

A depth-of-focus position recognizer 11 is configured to recognize a depth-of-focus position of a gesture of a user.

A gesture recognizer 12 is configured to recognize the gesture according to the depth-of-focus position of the gesture of the user and a 3D display image.

With this device, the depth-of-focus position recognizer recognizes the depth-of-focus position of the gesture of the user, and the gesture recognizer recognizes the gesture according to the depth-of-focus position of the gesture of the user and the 3D display image, so that a gesture on a 3D display can be recognized.

Optionally the device further includes a calibrator configured to preset a plurality of ranges of operation depth-of-focus levels for the user.

Optionally the depth-of-focus position recognizer is configured to recognize a range of operation depth-of-focus levels corresponding to the depth-of-focus position of the gesture of the user.

Optionally the gesture recognizer is configured to recognize the gesture on an object in the 3D display image in the range of operation depth-of-focus levels corresponding to the depth-of-focus position of the gesture of the user.

Optionally the calibrator is configured to preset the plurality of ranges of operation depth-of-focus levels for the user according to ranges of depths of focus of gestures of the user acquired when the user makes the gestures on objects at the different depths of focus in the 3D display image.

Optionally the device further includes a calibrator configured to predetermine a correspondence relationship between a value of operation depth of focus in a user gesture and a value of depth of focus in a 3D display image.

Optionally the gesture recognizer is configured to determine a value of depth of focus in the 3D display image corresponding to the depth-of-focus position of the gesture of the user according to the correspondence relationship, and to recognize the gesture in the 3D display image with the value of depth of focus.

Optionally the calibrator is configured to predetermine the correspondence relationship between a value of operation depth of focus in a user gesture and a value of depth of focus in a 3D display image according to normalized coordinates in the largest range of depths of focus that can be reached by a gesture of a user, and normalized coordinates in the largest range of depths of focus for a 3D display image.

Optionally the depth-of-focus position recognizer is configured to recognize the depth-of-focus position of the gesture of the user using a sensor and/or a camera, and the gesture recognizer is configured to recognize the gesture using a sensor and/or a camera.

Optionally the sensor includes one or a combination of an infrared photosensitive sensor, a radar sensor, and an ultrasonic sensor.

Optionally the depth-of-focus position recognizer and the gesture recognizer can share a part or all of the sensors, or can use their separate sensors, although the embodiment of the present disclosure will not be limited thereto.

Optionally the number of cameras may be one or more, although the embodiment of the present disclosure will not be limited thereto.

Optionally the depth-of-focus position recognizer and the gesture recognizer can share a part or all of the cameras, or can use their separate cameras, although the embodiment of the present disclosure will not be limited thereto.

Optionally the sensors are distributed at four of up, down, left and right edge frames of a non-display area.

Optionally the gesture recognizer is further configured to track using pupils, and to determine a sensor for recognizing the depth-of-focus position of the gesture of the user.

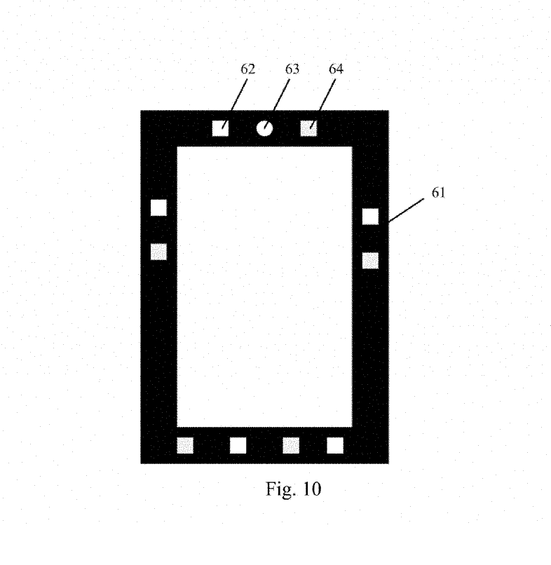

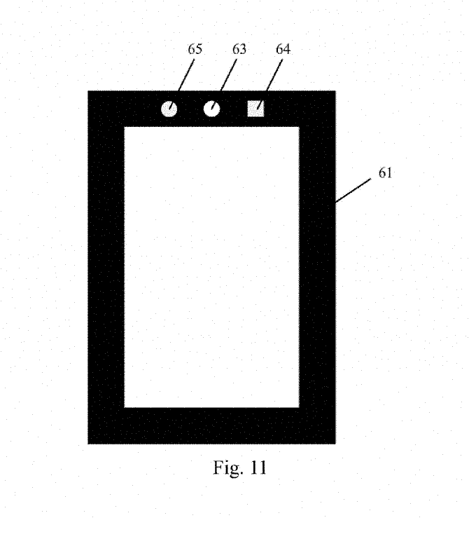

Tracking using pupils in the embodiment of the present disclosure is performed by determining an attention angle of view of a person as a result of tracking using the pupils, and then further selecting a detecting sensor approximately at the angle of view. In this solution, an object to be operated on by the person is preliminarily determined, and a sensor at a corresponding orientation is further used as a primary sensor for detection, so that the precision of detection can be greatly improved to thereby prevent an operational error. This solution can be applied in combination with a multi-sensor solution as illustrated in FIG. 10 for an improvement in precision.

Optionally the sensors are particularly arranged above one of: a color filter substrate, an array substrate, a backlight plate, a printed circuit board, a flexible circuit board, a back plane, and a cover plate glass.

It shall be noted that all of the depth-of-focus position recognizer, the gesture recognizer, and the calibrator in the embodiment of the present disclosure can be embodied by a processor, or another physical device.

A display device according to an embodiment of the present disclosure includes the device according to the embodiment of the present disclosure. The display device can be a mobile phone, a Portable Android Device (PAD), a computer, a TV set, or another display device.

In the calibration above of the device, each image to be displayed shall be calibrated in advance, so there is a significant workload. As an improvement thereto, only a calibration specification may be defined for the calibration of the device instead of calibrating the device in advance. When there is a touching gesture, the coordinates of the gesture are acquired, and further mapped to an object/page/model, etc., to be operated on by a human operator, according to the calibration specification. These two solutions have their respective advantages and disadvantages, and appropriate one of them can be selected as needed in a real operating scenario.

The device according to the embodiment of the present disclosure is provided as a hardware solution in which multiple technologies are integrated with multi-sensor sensing to thereby make use of their advantages and make up each other's disadvantages so as to detect a gesture precisely in a full range without being limited to any application scenario, e.g., a solution in which a plurality of sensors of the same category are bound, a solution in which sensors using different technologies are integrated, etc.

The sensors in the embodiment of the present disclosure will be described below in details.

An optical sensor obtains a gesture/body contour image which may or may not include depth information, and obtains a set of target points in a space in combination with a radar sensor or an ultrasonic sensor. The radar sensor and the ultrasonic sensor calculate coordinates using a transmitted wave reflected back after impinging on an object, and different electromagnetic waves are reflected back by different fingers while a gesture is being measured, thus resulting in a set of points. In an operation over a short distance, the optical sensor takes only a two-dimension photo, and the radar sensor or the ultrasonic sensor calculates a distance, a speed, a movement direction, etc., of a point corresponding to a reflected signal of a gesture. Both of them are superimposed onto each other to obtain precise gesture data. In an operation over a long distance, the optical sensor takes a photo, and calculates three-dimension gesture coordinates including depth information. An example thereof will be described below.

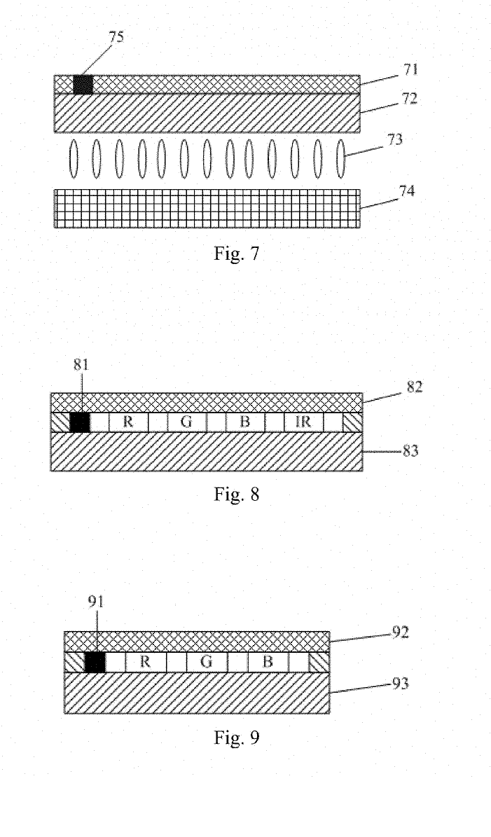

In a first implementation, there are a front camera, an infrared photosensitive sensor, and a radar or ultrasonic sensor as illustrated in FIG. 6, where the infrared photosensitive sensor 62, and the radar or ultrasonic sensor 64 are arranged on two sides of the front camera 63 in the non-display area 61 of the display device, and each sensor can be bound or trans-printed on a Printed Circuit Board (PCB), a Flexible Printed Circuit (FPC), a Color Film (CF) substrate, an array substrate (as illustrated in FIG. 8), a Back Plane (BP) (as illustrated in FIG. 9), or a cover plate glass (as illustrated in FIG. 7).

Referring to FIG. 7, a sensor 75 can be arranged on the cover plate glass 71, where there is the color filter substrate 72 below the cover plate glass 71, and there are liquid crystals 73 between the color filter substrate 72 and the array substrate 74.

Referring to FIG. 8, when the sensors are arranged on the array substrate side, for example, the photosensitive sensor is integrated with a pixel, and the radar/ultrasonic sensor 81 is arranged between the cover plate glass 82 and the back plane 83.

Referring to FIG. 9, when the sensors are arranged on the back plane, for example, the photosensitive sensor is arranged between the cover plate glass 92 and the back plane 93.

Referring to FIG. 10, the sensors can be located at the top, bottom, and/or two sides of the non-display area, and the number of each category of sensors may be one, or may be more than one, where they are located at different positions, so that respective one of the sensors at a position corresponding to the position where the human operator stands is selected to make measurement to thereby improve the precision. Firstly a primary sensor acquires and feeds back the position of the person to the device, and the device instructs the sensor at the corresponding position to be enabled to acquire data. For example, if the person is standing on the left, then a sensor on the left may be enabled to make measurement.

In a second implementation, there is a dual-camera and a radar or ultrasonic sensor. As illustrated in FIG. 11, the dual-camera includes a primary camera 63 configured to take an RGB image, and a secondary camera 65 configured to provide a parallax together with the primary camera for calculating depth information. The primary and secondary cameras may or may not be the same camera, and there are two positions of the two cameras, so the same object is imaged differently, like different scenes seen by left and right human eyes, thus resulting in a parallax; and the coordinates of the object can be derived using a triangular relationship. This is known in the prior art, so a repeated description thereof will be omitted here. The depth information is a Z coordinate. In an operation over a short distance, the secondary camera is disabled, and only the primary camera is enabled to take a two-dimension photo; and the radar or ultrasonic sensor 64 calculates a distance, a speed, a movement direction, etc., of a point corresponding to a reflected signal of a gesture. Both of them are superimposed onto each other to obtain precise gesture data. In an operation over a long distance, the dual-camera and the sensor take photos and calculate the coordinates of a three-dimension gesture including depth information.

It shall be noted that alternatively a plurality of cameras, and a plurality of sensors can be arranged in the non-display area, where the plurality of cameras can be cameras of the same category, or can be cameras of different categories, and the plurality of sensors can be sensors of the same category, or can be sensors of different categories.

In summary, the technical solutions according to the embodiments of the present disclosure relate to a display device, a device and method for interaction using a gesture in a three-dimension field of view, where multiple technologies are integrated to thereby make use of their advantages and make up each other's disadvantages, and there are a plurality of sensors, where a sensor at a corresponding orientation is enabled through tracking using pupils, thus improving the precision of detection. Furthermore the display device is integrated with the sensors, for example, bound or trans-printed on a color filter substrate, an array substrate, back plate, a Back Light Unit (BLU), a printed circuit board, a flexible circuit board, etc.

Those skilled in the art shall appreciate that the embodiments of the disclosure can be embodied as a method, a device or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, an optical memory, etc.) in which computer useable program codes are contained.

The disclosure has been described in a flow chart and/or a block diagram of the method, the device and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A device for recognizing a gesture, the device comprising:
a depth-of-focus position recognizer configured to recognize a depth-of-focus position of a gesture of a user; and
a gesture recognizer configured to recognize the gesture according to the depth-of-focus position of the gesture of the user and a 3D display image.

2. The device according to claim 1, wherein the device further comprises:
a calibrator configured to preset a plurality of ranges of operation depth-of-focus levels for the user.

3. The device according to claim 2, wherein the depth-of-focus position recognizer is configured to recognize a range of operation depth-of-focus levels corresponding to the depth-of-focus position of the gesture of the user.

4. The device according to claim 3, wherein the gesture recognizer is configured to recognize the gesture on an object in the 3D display image in the range of operation depth-of-focus levels corresponding to the depth-of-focus position of the gesture of the user.

5. The device according to claim 2, wherein the calibrator is configured:
to preset the plurality of ranges of operation depth-of-focus levels for the user according to ranges of depths of focus of gestures of the user acquired when the user makes the gestures on objects at the different depths of focus in the 3D display image.

6. The device according to claim 1, wherein the device further comprises:
a calibrator configured to predetermine a correspondence relationship between a value of operation depth of focus in a user gesture and a value of depth of focus in a 3D display image.)

7. The device according to claim 6, wherein the gesture recognizer is configured:
to determine a value of depth of focus in the 3D display image corresponding to the depth-of-focus position of the gesture of the user according to the correspondence relationship, and to recognize the gesture in the 3D display image with the value of depth of focus.

8. The device according to claim 6, wherein the calibrator is configured:
to predetermine the correspondence relationship between a value of operation depth of focus in a user gesture and a value of depth of focus in a 3D display image according to normalized coordinates in the largest range of depths of focus that can be reached by a gesture of a user, and normalized coordinates in the largest range of depths of focus for a 3D display image.

9. The device according to claim 1, wherein the depth-of-focus position recognizer is configured to recognize the depth-of-focus position of the gesture of the user using a sensor and/or a camera; and
the gesture recognizer is configured to recognize the gesture using a sensor and/or a camera.

10. The device according to claim 9, wherein the sensor comprises one or a combination of an infrared photosensitive sensor, a radar sensor, and an ultrasonic sensor.

11. The device according to claim 10, wherein sensors are distributed at four of up, down, left and right edge frames of a non-display area.

12. The device according to claim 11, wherein the gesture recognizer is further configured to track using pupils, and to determine a sensor for recognizing the depth-of-focus position of the gesture of the user.

13. The device according to claim 11, wherein the sensors are arranged above one of: a color filter substrate, an array substrate, a backlight plate, a printed circuit board, a flexible circuit board, a back plane, and a cover plate glass.

14. A display device, comprising a device for recognizing a gesture, the device comprising:
a depth-of-focus position recognizer configured to recognize a depth-of-focus position of a gesture of a user; and
a gesture recognizer configured to recognize the gesture according to the depth-of-focus position of the gesture of the user and a 3D display image.

15. A method for recognizing a gesture, the method comprising:
recognizing a depth-of-focus position of a gesture of a user; and
recognizing the gesture according to the depth-of-focus position of the gesture of the user and a 3D display image.

16. The method according to claim 15, wherein the method further comprises:
presetting a plurality of ranges of operation depth-of-focus levels for the user.

17. The method according to claim 16, wherein recognizing the depth-of-focus position of the gesture of the user comprises:
recognizing a range of operation depth-of-focus levels corresponding to the depth-of-focus position of the gesture of the user.

18. The method according to claim 17, wherein recognizing the gesture according to the depth-of-focus position of the gesture of the user and the 3D display image comprises:
recognizing the gesture on an object in the 3D display image in the range of operation depth-of-focus levels corresponding to the depth-of-focus position of the gesture of the user.

19. The method according to claim 16, wherein presetting the plurality of ranges of operation depth-of-focus levels for the user comprises:
presetting the plurality of ranges of operation depth-of-focus levels for the user according to ranges of depths of focus of gestures of the user acquired when the user makes the gestures on objects at the different depths of focus in the 3D display image.

20. The method according to claim 15, wherein the method further comprises: predetermining a correspondence relationship between a value of operation depth of focus in a user gesture and a value of depth of focus in a 3D display image;
optionally recognizing the gesture according to the depth-of-focus position of the gesture of the user and the 3D display image comprises:
determining a value of depth of focus in the 3D display image corresponding to the depth-of-focus position of the gesture of the user according to the correspondence relationship, and recognizing the gesture in the 3D display image with the value of depth of focus;
optionally predetermining the correspondence relationship between a value of operation depth of focus in a user gesture and a value of depth of focus in a 3D display image comprises:
predetermining the correspondence relationship between a value of operation depth of focus in a user gesture and a value of depth of focus in a 3D display image according to normalized coordinates in the largest range of depths of focus that can be reached by a gesture of a user, and normalized coordinates in the largest range of depths of focus for a 3D display image.

21. (canceled)

22. (canceled)
